(19) United States
(12) Patent Application Publication
(10) Pub. No.: US 2009/0147744 A1
(43) Pub. Date: Jun. 11, 2009

(54) Scalable control channel design for OFDM-based wireless systems

(75) Inventors: Martin Dottling, Neubiberg (DE); Jorn Von Hafen, Herford (DE)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/284,355

(22) Filed: Sep. 19, 2008

Related U.S. Application Data
(60) Provisional application No. 60/973,549, filed on Sep. 19, 2007.

(51) Int. Cl. H04W 72/00; H04L 27/28

(52) U.S. Cl. 370/329; 375/260

(57) ABSTRACT

Overhead is kept small by a scalable control channel design suitable for OFDMA-based systems with many resource elements and many active users. For instance, optimization of control information in a wideband OFDMA-based radio system with up to 200 resource elements and multiple spatial layers and up to 1000 active users is possible. In contrast to existing approaches in LTE and WINNER, optimized flexible-length downlink control information is shown, which reduces overhead by a combination of slow and fast control signalling, of broadcast and multicast signalling, as well as of individual and table-based allocation information.

### CROSS-REFERENCE TO RELATED APPLICATION

This application claims priority from U.S. Provisional Application Ser. No. 60/973,549 filed Sep. 19, 2007.

### BACKGROUND OF THE INVENTION

1. Technical Field

The invention relates to wireless communications and, more particularly, to Orthogonal Frequency Division Multiple Access (OFDMA)-based wireless cellular systems such as 3GPP Long-Term Evolution (LTE), forthcoming evolutions thereof and standards targeting IMT-Advanced, like the radio system developed within the European research project WINNER.

2. Discussion of Related Art

### Abbreviations

3GPP Third generation partnership program
AT Allocation Table
BI Basic Information
CCE Control Channel Elements
CQI Channel Quality Information
CT Configurable Table
FDD Frequency Division Duplex
HARQ Hybrid Automatic Repeat Request
ID Identification
IMT International Mobile Communications
LI Length Indicator
LTE Long Term Evolution
MCS Modulation and Coding Scheme
MIMO Multiple Input Multiple Output
OFDMA Orthogonal Frequency Division Multiple Access
RAN Radio Access Network
RE Resource Element
SINR Signal to Interference-plus-Noise Ratio
TFT Transport Format Table
UE User Equipment
UTRAN Universal Terrestrial Radio Access Network
WINNER Wireless Initiative New Radio

A particular advantage of OFDMA-based wireless systems is that opportunistic scheduling can be done in several dimensions, such as time, frequency, and space. Small portions of the overall radio resources, so-called resource elements (RE) can be individually and flexibly allocated to different users.

This allows fostering significant scheduling gains, but on the other hand requires informing the peer entity (e.g. the user equipment (UE) in case of downlink) about which RE are allocated to him. Thus either excessive control signaling to express which A resource elements (RE) out of N total resource elements are assigned to a particular user will result or the flexibility of the adaptive scheduling must be reduced by limiting the possible assignments. The latter would, however, also restrict the available gain due to opportunistic scheduling.

An straight-forward encoding of all possible allocations of Aε{1, . . . , N} RE out of N would require N bits. Using dedicated control signaling, this needs to be signalled to all scheduled users, i.e. the total information overhead could be up to N² bits (if each resource element is allocated to a different user). Since this control information needs to be highly reliable, strong coding is required and high overall control overhead results. The problem becomes especially prominent for systems with a large number of available RE, like future IMT-Advanced systems with high bandwidth and/or high spatial re-use of RE.

For large allocations to one user, the SINR in each RE might vary significantly and therefore adaptive modulation per RE within one codeword is proposed in WINNER. This invention also provides an efficient signaling approach for transmitting the increased payload for modulation information.

A particular focal point is also that depending on the current operation point of a cell, such future systems need to maintain low control signaling overhead for few high-rate users, as well as for many low-rate users. Due to the increased spectral efficiency and bandwidth, the number of users that a scheduler can immediately assign resources (called active users in the following) will increase considerably. Therefore also the design of the control channel needs to scale with these different operation conditions and maintain low overhead and at the same time high flexibility of resource assignment.

The invention is therefore targeting the optimization of downlink control information for systems with up to ≧200 RE and multiple spatial layers and up to ≧600 active users.

The resource allocation information problem has been mentioned in various standardization documents. For LTE, a starting point for design of the DL Control Channel Structure in LTE is provided in the 3GPP RAN1 Tdoc R1-071820.

The different approaches, like combinatorial, bitmaps, split bandwidth bitmaps, sub-band (“Island”), or tree approaches are summarized in the 3GPP RAN1 Tdoc R1-073227.

Related Art also includes U.S. application Ser. Nos. 11/509,697, 60/796,547, and 60/799,920. Also for reference are assignee's standardization meeting R-documents R1-061907 and R1-061908 for the 3GPP TSG-RAN WG1 LTE standardization meeting held 27-30 Jun. 2007 in Cannes, France.

All methods reduce overhead by limiting the number of possible allocations in different ways. This reduces the achievable gain. Furthermore, these algorithms are based on fixed length of control information elements and of the total control information channel allocation. They therefore do not adapt and scale with varying operational scenarios with respect to number of users, user data rate, etc.

### SUMMARY OF THE INVENTION

It is to be understood that all presented exemplary embodiments may also be used in any suitable combination.

According to a first aspect of the invention, a method is provided, comprising:
transmitting or receiving resource allocation information over a control channel of a radio interface in which resources for said transmitting or receiving are adaptively allocated in several dimensions and in several parts so that said resources are individually and flexibly allocated to different terminals of different users receiving said information over said radio interface, and
separately coding said information before said transmitting or separately decoding said information after said receiving.

According to a second aspect of the present invention, apparatus is provided configured to transmit or receive resource allocation information over a control channel of a radio interface in which resources for transmitting or receiving are adaptively allocated in several dimensions and in several parts so that said resources are individually and flexibly allocated to different terminals of different users receiving said information over said radio interface, and configured to separately code said information before said transmitting or separately decode said information after said receiving.

According to a third aspect of the present invention, a system is provided configured to transmit and receive resource allocation information over a control channel of a radio interface in which resources for transmitting and receiving are adaptively allocated in several dimensions and in several parts so that said resources are individually and flexibly allocated to different terminals of different users receiving said information over said radio interface, and configured to separately code said information before said transmitting and separately decode said information after said receiving.

According to a fourth aspect of the present invention, a computer readable medium or an integrated circuit is provided configured to transmit or receive resource allocation information over a control channel of a radio interface in which resources for transmitting or receiving are adaptively allocated in several dimensions and in several parts so that said resources are individually and flexibly allocated to different terminals of different users receiving said information over said radio interface, and configured to separately code said information before said transmitting or separately decode said information after said receiving.

This invention is intended to be used in LTE products, such as base stations and user terminals. It can also be used in future OFDMA-based radio standards, such as forthcoming IMT-Advanced systems.

The invention keeps overhead small by a scalable control channel design suitable for instance for OFDMA-based systems with many resource elements and many active users.

Without limitation, the invention is novel in one or more of the following ways over the prior art:
*signalling in one or more of the following three steps (parts): configuration, allocation and TFT, which allows additional compression due to a-priori knowledge.
the exact staggering of information (what is sent in which part) to allow high compression rates.
description of individual resource allocation information and the associated optimization due to a-priori knowledge of how many REs are allocated.
switching between individual and table-based approaches.
different structure for TFI and pointer to next part: in Tdoc it is staggered, i.e. UEs need to read the fields with lower order to retrieve the TFI for their variable part; in this invention this is not necessary.
the total length of all information parts is known to all users, allowing for a re-use of the remaining physical resources for data.

Although the invention targets optimization of control information in wideband OFDMA-based radio systems with up to 200 resource elements and multiple spatial layers and up to 1000 active users it is not limited thereto and may be readily targeted to similar applications. In contrast to existing approaches in LTE and WINNER, the invention is based on optimized flexible-length downlink control information, which reduces overhead by a combination of slow and fast control signalling, of broadcast and multicast signalling, as well as of individual and table-based allocation information.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 shows the structure of the configuration table CT with and without the optional fields Kᵢ indicating the number of maximum resource elements allocated to one particular user.

FIG. 2 shows the structure of the length indicator LI containing a pointer to the first resource element containing data

FIG. 3 explains the sequence of the allocation tables AT, which all use different modulation and coding schemes (MCS) and provides the detailed structure for one AT.

FIG. 4 shows the described resource mapping alternatives for an instructive example of 8 resource elements (RE) and 4 scheduled users; in case A the allocated resources are signalled for the 4 scheduled users, whereas in case B for the sequence of resource elements the scheduled user sub-indices are used. The latter case results in less overhead in this example.

FIG. 5 provides a synopsis of the different elements of the control information and explains the use of the pointers.

FIG. 6 shows required information bits versus the average number of RE per user for signalling the resource allocation with full flexibility using either individual resource allocation tables (case A) or based on a common table using the user indices (case B) for the WINNER FDD mode and 8 active users organized in 2 control groups.

FIG. 7 shows required overhead fractions versus the average number of RE allocated to one user for the different elements of the downlink control for the WINNER FDD mode and 8 active users organized in 2 control groups.

FIG. 8 shows required information bits versus the average number of RE per user for signalling the resource allocation with full flexibility using either individual resource allocation tables (case A) or based on a common table using the user indices (case B) for the WINNER FDD mode and 64 active users organized in 4 control groups.

FIG. 9 shows required overhead fractions versus the average number of RE allocated to one user for the different elements of the downlink control for the WINNER FDD mode and 64 active users organized in 4 control groups.

FIG. 10 shows required information bits versus the average number of RE per user for signalling the resource allocation with full flexibility using either individual resource allocation tables (case A) or based on a common table using the user indices (case B) for the WINNER FDD mode and 320 active users organized in 5 control groups.

FIG. 11 shows required overhead fractions versus the average number of RE allocated to one user for the different elements of the downlink control for the WINNER FDD mode and 320 active users organized in 5 control groups.

FIG. 12 shows required information bits versus the average number of RE per user for signalling the resource allocation with full flexibility using either individual resource allocation tables (case A) or based on a common table using the user indices (case B) for the WINNER FDD mode and 640 active users organized in 5 control groups.

FIG. 13 shows required overhead fractions versus the average number of RE allocated to one user for the different elements of the downlink control for the WINNER FDD mode and 640 active users organized in 5 control groups.

FIG. 14 shows required overhead fractions versus the average number of RE allocated to one user for the different elements of the downlink control for the WINNER TDD mode and 640 active users organized in 5 control groups.

FIG. 15 shows required overhead fractions versus the average number of RE allocated to one user for the different elements of the downlink control for the WINNER TDD mode and 1280 active users organized in 5 control groups.

FIG. 16 shows a general purpose signal processor suitable for carrying out the protocol construction, formatting and signal processing functions described in connection with the present disclosure.

### DETAILED DESCRIPTION OF THE INVENTION

In contrast to existing approaches in LTE and WINNER, the invention is based on optimized flexible-length downlink control information, which reduces overhead by a combination of slow and fast control signalling, of broadcast and multicast signalling, as well as of individual and table-based allocation information.

The approach
allows flexible configuration of the control information that allows to adopt and optimize overhead to a large range of operation conditions (e.g. ranging from few high-rate users to many low-rate users, full load, low load),
supports switching between individual and table-based indication of allocated RE depending on the operation conditions,
saves overhead due to mapping of users into different control groups based on their average SINR, which maintains the advantages of multicasting information, but uses different modulation and coding of control information, therefore avoiding that the total overhead is dominated by the strongly-encoded information sent to users in bad conditions,
minimizes the information that needs to be decodable by all user terminals, while keeping full flexibility of resource element (chunk) allocation,
applies adaptive length of control information that allows re-use of left-over physical resources for data transmission, i.e. no waste of resources due to pre-determined overall length of the control information,
allows efficient channel coding of the resource allocation and transport format information.

This method works as follows:
The control signalling is organized in several parts:
   “a priori” knowledge on basic information BI and constants,
   a slow broadcast configuration table CT,
   an optional broadcast control message length indicator LI,
   multicast allocation tables AT per control group, and
   multicast transport format tables TFT per control group.

The following basic information BI is known a priori, e.g. by information at cell association, other signalling with slow update rate, or by a fixed pre-determined rule:
number of control groups N_{CG}, i.e. groups that receive multicast control information with different modulation and coding MCS_{CG}
   maximum number of users per control group N_{max,i}, i=1, . . . , N_{CG}
      a particular implementation could be that an equal number of maximum users is allowed in all control groups
      unicast control signalling can be configured as a special case with many groups each containing only one connection
   maximum number of resource elements (RE) allocated to one particular user in each control group K_{max,i}
   the size (i.e. number of bits) of the pointers defined further below
   transmission formats, physical resources and their sequence of usage for downlink control information
      this includes the configuration of the control message, i.e., whether case A or case B described below is used in the cell. Case A refers to a per-user information, which RE are allocated to him, whereas case B is a table-based approach using user indices indicating which RE are allocated to different users. It will be shown, that depending on the operation conditions either case A or case B shall be used and only the combination of both possibilities allows small overhead in all conditions.
   mapping of the user to a control group (based on the users' average channel quality) and its particular index in this group, i.e. index ij which serves as a short user ID
   the length of control channel information elements with fixed length,
   information on the total number of resource elements Rᵢ for each control group in the cell
The following configuration table CT is jointly encoded, protected (e.g. by a cyclic redundancy check CRC), and broadcast in the cell at a timescale comprising at least one, typically many resource allocation time steps (called slots in the following):
   the actual number of users in each control group Nᵢ (requires ceil(log₂(N_{max,i})) information bits per entry), i.e. the number of users that can be scheduled in this control group
   optionally the actual number of maximum resource elements allocated to one particular user in each control group Kᵢ (requires ceil(log₂(K_{max,i})) information bits per entry)
      this option allows to further reduce the size of the following tables, in particular by reducing the number of resource allocation possibilities that need to be signalled. If this option is not used, the following applies by setting Kᵢ=K_{max,i}.
   Due to the fact that this table needs to be decodable for all users in the cell, it needs strong protection (i.e. high coding overhead). The information in table CT has been tailored such, that it provides minimum information length but allows high savings for the following tables.
   FIG. 1 shows the structure of the configuration table CT with and without the optional fields Kᵢ indicating the number of maximum resource elements allocated to one particular user.

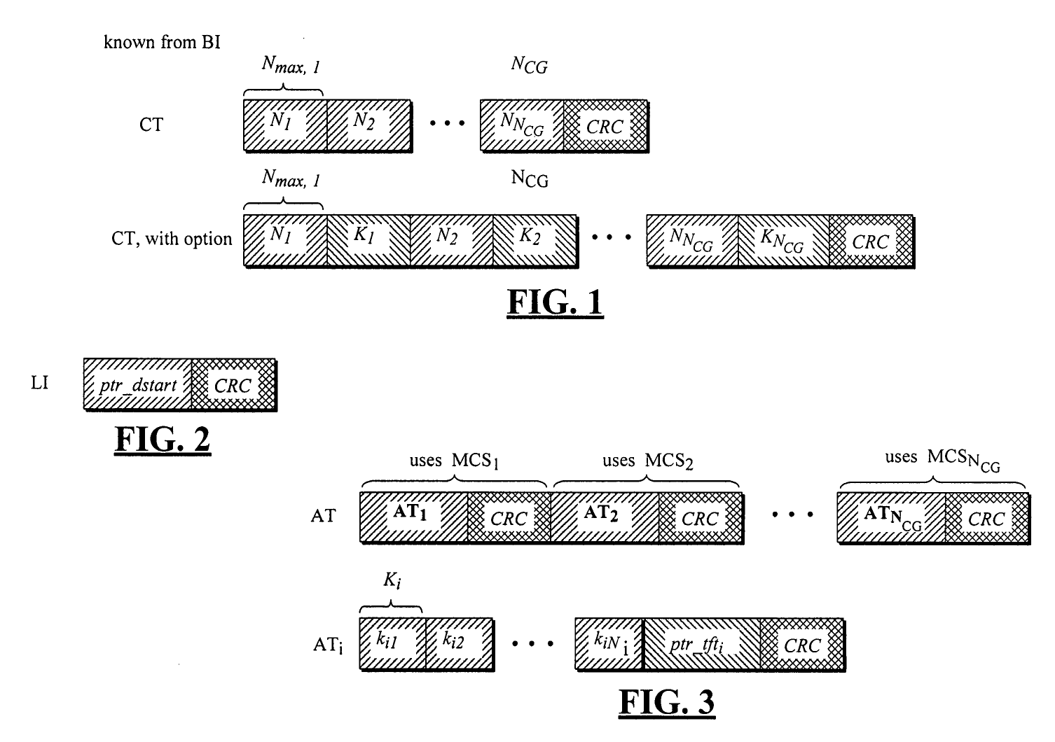

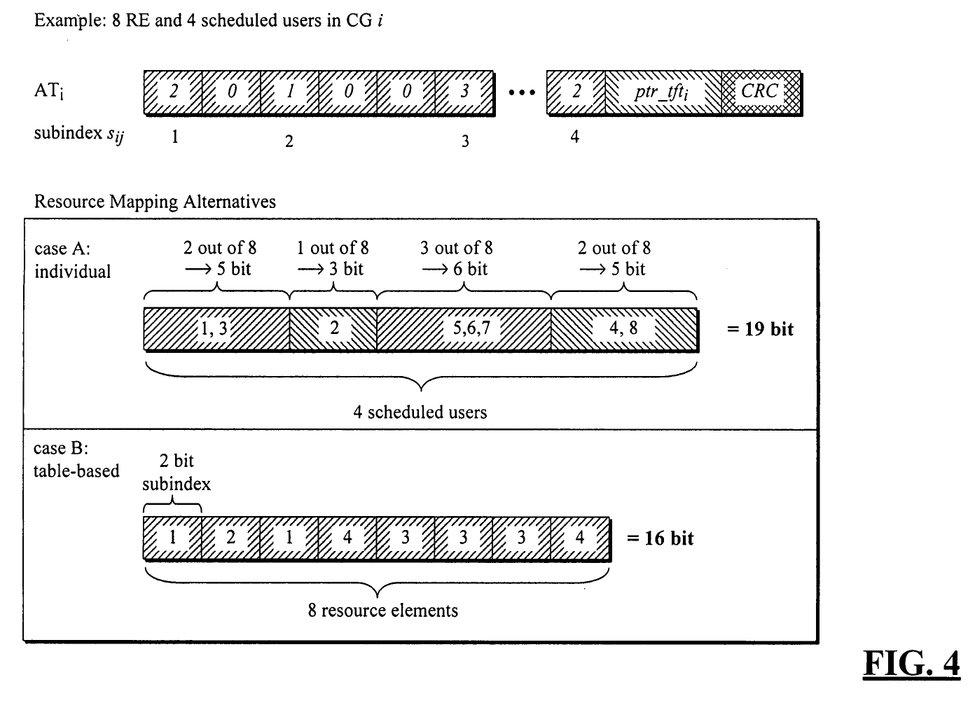

The main purpose of the CT is to distribute basic information on the following control-group specific information with minimal number of information bits. In particular the actual number of users in each control group allows tailoring and reducing the size of the following allocation table AT.
An optional control message length indicator LI is broadcast every slot. It contains a pointer ptr_dstart to the first entry of the pre-defined physical resources for downlink control information, which is unused for control purposes. Starting from this entry these resources will then be used for transmission of data.
   In case the LI is not used, these resources remain unused
   In most of the cases the additional overhead due to broadcasting the LI will be less than the achievable savings due to re-use of left-over resource elements and the use of LI is therefore recommended. However, whether LI is used can be part of the cell configuration.
   The LI needs also to be decodable for all users, i.e. it requires strong protection. As it needs to be sent every slot, especially this kind of information has been minimized.
   FIG. 2 shows the structure of the length indicator LI containing a pointer to the first resource element containing data.

The major benefit is that LI enables flexible length control information and efficient use of the remaining radio resources for data. This allows adaptation to a wide range of operational scenarios.
For each of the configured control group an allocation table ATᵢ is jointly encoded and protected (e.g. by a CRC). Each ATᵢ uses its particular modulation and coding MCSᵢ that allows all users in control group i to decode the information.
   This allows to maintain the efficiency of multicasting, while avoiding that strong coding (needed for the users with bad SINR) is required for all information
   The encoded allocation tables ATᵢ are written sequentially in the pre-defined physical resources, the length of each table can be determined by any user from the information contained in the CT. Each user can therefore determine which part of these resources contains the AT for his control group.
The content of one ATᵢ is as follows:
   a pointer ptr_tftᵢ to the physical resource where TFTᵢ starts, thus allowing all users of one control group to retrieve the remaining control information without the need to be able to decode ATₖ with k≠i (i.e. the ATs of the other control groups)
      as the total length of all ATs is known based on the information contained in the CT the position where TFT₁ starts is also known and therefore for control group 1 this pointer needs not be signalled explicitly. In a preferred implementation, therefore the pointer to the starting point of TFTᵢ is only used for i>1.
      the pointer approach allows flexible length of control information and therefore allows adaptation to a wide range of total number of scheduled connections
   in case A, where individual resource mapping is used: Nᵢ entries k_{i,j} defining the number of RE allocated to user with index j in control group i. Each entry has ceil(log₂(Kᵢ)) information bits in case Kᵢ is signalled with CT, K_{max,I} otherwise.
      k_{i,j}=0 for users that are not scheduled in the particular slot
   FIG. 3 shows the sequence of the allocation tables AT, which all use different modulation and coding schemes (MCS) and provides the detailed structure for one AT

The AT contains not only information about which users are scheduled, but additionally, how many resources are allocated to a particular user. This allows efficient compression of the transport format information contained in the subsequent TFT. In particular the information which resources are allocated to a particular user and the adaptive modulation information per RE can be efficiently reduced as explained in what follows.
The transport format tables TFTᵢ contain the necessary information for each user ij on:
   which RE are allocated,
   mapping of codeblocks to RE,
   transport format of the codeblocks,
   HARQ information (one HARQ channel may contain one or several codeblocks),
   etc.
Many particular implementation of the TFT format are possible, the above invention, however allows to benefit from the following a priori knowledge provided by the preceding tables:
   Entries are only generated for scheduled users, i.e. k_{i,j}>0,
   In case A, where individual resource mapping is used:
      The actual RE allocated can be signalled very efficiently for each of the users, since it is a priori known how many resources k_{i,j} are allocated per user. This means that even for full flexibility of resource allocation only all possible combinations of k_{i,j} out of R need to be signalled. Therefore the length of the resource allocation information is upper bounded by

$$ceil ( {log}_{2} ( \begin{matrix}{k}_{i , j} \\ {R}_{i}\end{matrix} ) ) ,$$

where Rᵢ is the total number of RE that can be used in each control group. Rᵢ can either correspond to the total number of available RE for full flexibility or to a subset of possibilities pre-defined by other means. The length of the resource allocation information field will therefore be flexible and user-specific. A separate mapping is encoded for each scheduled user. Case A is in particular relevant for relatively large RE allocations to few users
In case B, where a table-based resource mapping is used:
   For each control group i a subindex s is established containing only the users ij with k_{i,j}>0, i.e. users that are scheduled. Each user ijₐ can calculate his subindex sᵢⱼ based on the information contained in the AT, by simply counting the entries of users with j≦jₐ in his control group i. Let Sᵢ≦Nᵢ denote the number of actually scheduled users in control group i. This subindices s are now signalled in a matrix, where the matrix position corresponds to the corresponding index of the RE. This requires

$${\sum }_{i = 1}^{{N}_{CG}} {R}_{i} \cdot ceil ( {log}_{2} ( {S}_{i} ) )$$

information bits, but allows to remove the kᵢⱼ fields in ATᵢ since the allocated RE can now be detected from the table. Case B results in lower overhead in case of many users with relatively small RE allocations. Since all users of one control group have knowledge of Sᵢ in general less bits can be used per entry, i.e. although Nᵢ users can be scheduled very fast (and thus are in an active state), the length of the major part of the actual control information is only determined by the number of scheduled user in the current time step Sᵢ. This allows the system to keep a large number of users in active state without high control overhead.
FIG. 4 shows the described resource mapping alternatives for an instructive example of 8 resource elements (RE) and 4 scheduled users. In case A the allocated resources are signaled for the 4 scheduled users. The first scheduled user is allocated RE 1 and 3. As there are 28 possibilities for 2 out of 8, 5 bit would be required to have signal any combination. The same calculation is done for all users, resulting in a total length of the resource mapping of 19 bits. In case B 2-bit entries containing the sub-index of the 4 scheduled users are written and each entry corresponds to one of the 8 RE, yielding a total of 16 bit overhead. Therefore in this particular example, case B would be preferable.
The modulation information might either be given explicitly per RE layer (requiring 2 bit each) or based on a basic modulation, which is given once per codeword and then signalling of the difference in modulation
   this differential signalling can e.g. consist of the three states (up/same/down), which would allow to span the two modulation formats adjacent to the basic modulation and therefore cover the majority of cases and only restrict flexibility a little. In this case a joint encoding of the modulation difference for each layer of a chunk would require

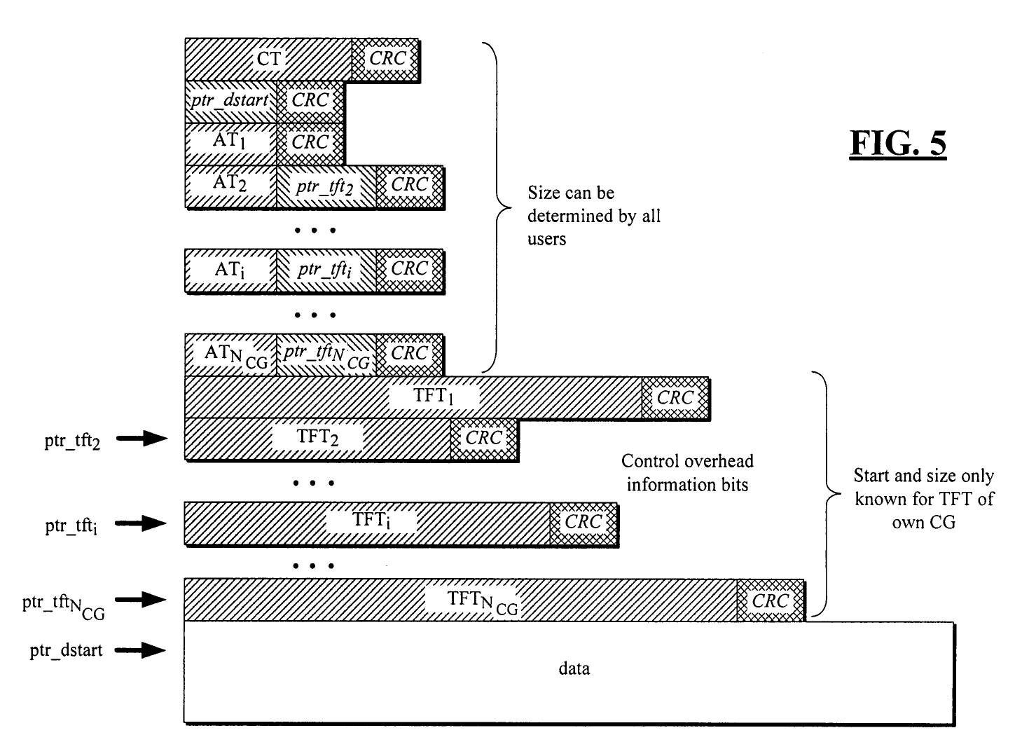

ceil(log₂(3^{R}^{ᵢ}))
information bits.
A sequential mapping of codeblocks to RE is proposed, therefore it is sufficient to indicate the RE where the current codeblock ends (“end RE”). This end point can efficiently be signalled by using an index into the k_{i,j} RE allocated to user ij, i.e. it only requires ceil(log₂(k_{i,j})) information bits
   If the “end RE” field contains the number of the highest RE allocated, the last codeblock of this user is reached and the subsequent information block belongs to the next scheduled user (otherwise information for the next codeblock of the current user follows). This implicit signalling of information block borders further reduces overhead.
   An alternative implementation might require that codeblocks of equal size are used only and therefore indicating the number of codeblocks is sufficient.
   In case several codeblocks are sent by one HARQ channel, information that maps the codeblocks to HARQ channels needs to be contained additionally.
FIG. 5 provides a synopsis of the different elements of the control information and explains the use of the pointers. For the first transport format table no pointer ptr_tft₁ is required, since the starting point of this table can be determined by all users. Ptr_dstart can be read by all users. The entries readable for all users that are member of control group (CG) i are shown with bold boundaries.

The above invention is very flexible and therefore suitable for future systems, e.g. of the IMT-Advanced family. It allows to configure the control signalling depending on the traffic, service, and load pattern and supports optimized overhead for a wide range of operational scenarios, e.g. wrt. number of RE, number of users, number of flows, etc.

The benefits of this approach are demonstrated by the following assumptions in accordance with and derived from the frequency-adaptive transmission mode of the WINNER FDD physical layer mode described in D6.13.7 of the European research project WINNER:
Rₜₒₜ=144 RE per slot
96 symbols per RE
4 spatial layer per RE
40 codewords (retransmission units with own HARQ-ID) per slot
CRC length=12 bit

Additionally some results are shown for the WINNER TDD physical layer mode, where Rₜₒₜ=230 RE and 120 symbols exist per RE.

The number of active users and control groups is varied in order to show that low control overhead is achieved in a wide range of operational scenarios.

The different tables described above have different requirements in terms of coding and temporal update rate. For the overhead calculation example the following assumptions (corresponding to an average operational case) were taken:
BI overhead is signalled very rarely and therefore negligible,
CT needs high protection as it needs to be decoded by all users, therefore 16 symbols/information bit are assumed, temporal update rate is assumed every 16^{th} slot (every 2 superframes in WINNER, i.e. still a high update rate every 11.5 ms), effective multiplication factor: 1 symbol/information bit/slot
LI needs also high protection, but is sent every slot, effective multiplication factor: 16 symbols/information bit/slot
AT and TFT information need to be sent every slot, however they have an optimized modulation and coding format within each control group. Averaged over the population of scheduled users it is assumed that the effective multiplication is 2 symbols/information bit/slot

The following implementation for the TFT format is investigated:
asynchronous HARQ based on n-channel stop-and-wait protocol, supporting incremental redundancy and using
   2 bit for redundancy version
   1 bit for new data indicator
5 bit for code rate/transport block size
5 bit to describe the MIMO scheme used
2 bit description of basic modulation format of the code word and describes the actual modulation of the individual RE belonging to this codeword using differential encoding based on 3 states (up/same/down)
stop index of chunk is given, i.e. variable size of codewords is supported

For the following configurable parameters an upper bound was used:
R_{I}=Rₜₒₜ, i.e. all resources can be used in all control groups
for the WINNER FDD mode 144 RE are assumed
for the WINNER TDD mode 230 RE are assumed
a spatial scheme with 4-time re-use of RE in spatial domain is employed, thus introducing 4 spatial layers per RE
modulation information is required for all spatial layers of each RE

For the variable-length information fields an average was assumed, in particular:
K_{max,I}=Rₜₒₜ/N_{CG}, i.e. the maximum number of RE allocated to one particular users is the total number of RE divided by the number of control groups
the actually used number of RE kᵢⱼ is identical for all users, i.e. for a given number of RE per users, the total number of users is calculated by Nᵤ=ceil(Rₜₒₜ/kᵢⱼ)
it is assumed that the 40 codewords per slot are equally distributed amongst the users and the length of the HARQ-ID field is assumed to configured accordingly, i.e. ceil(log₂(40/Nᵤ)

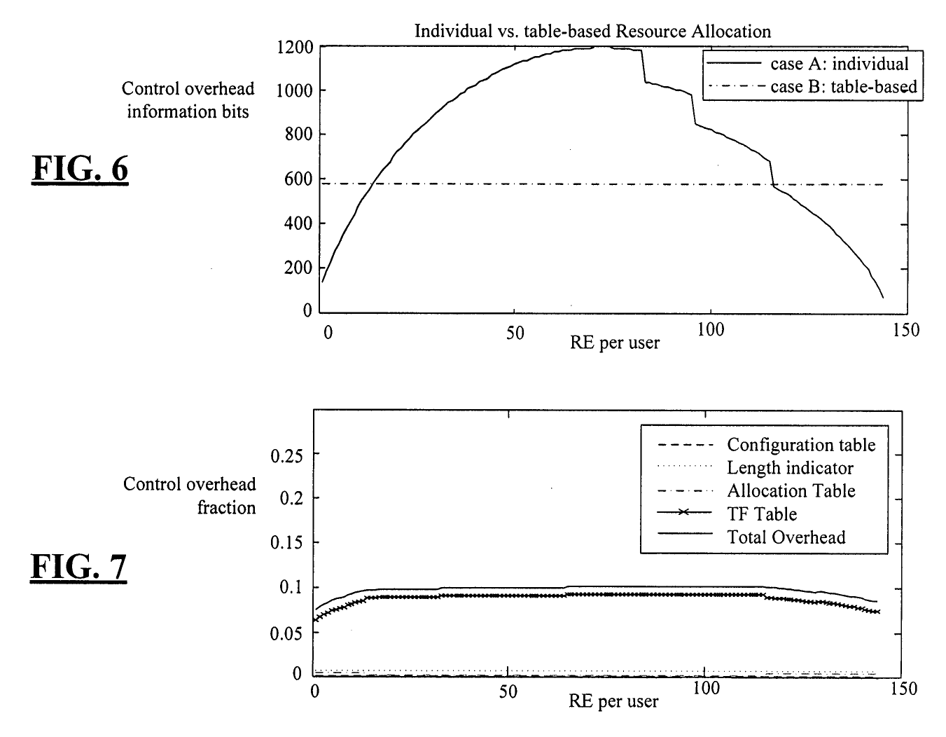

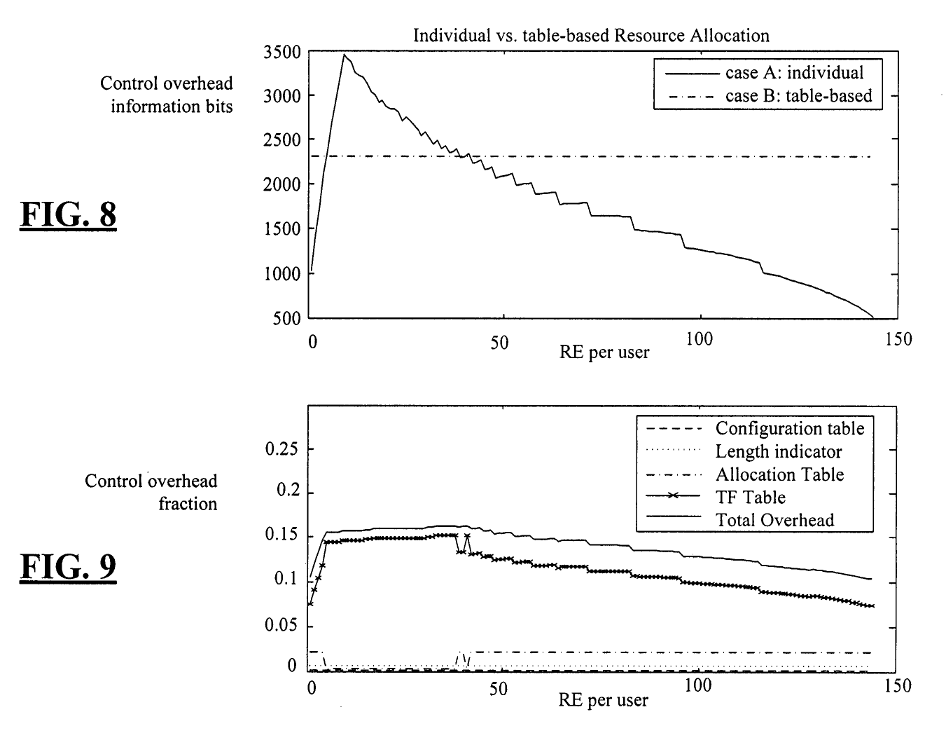

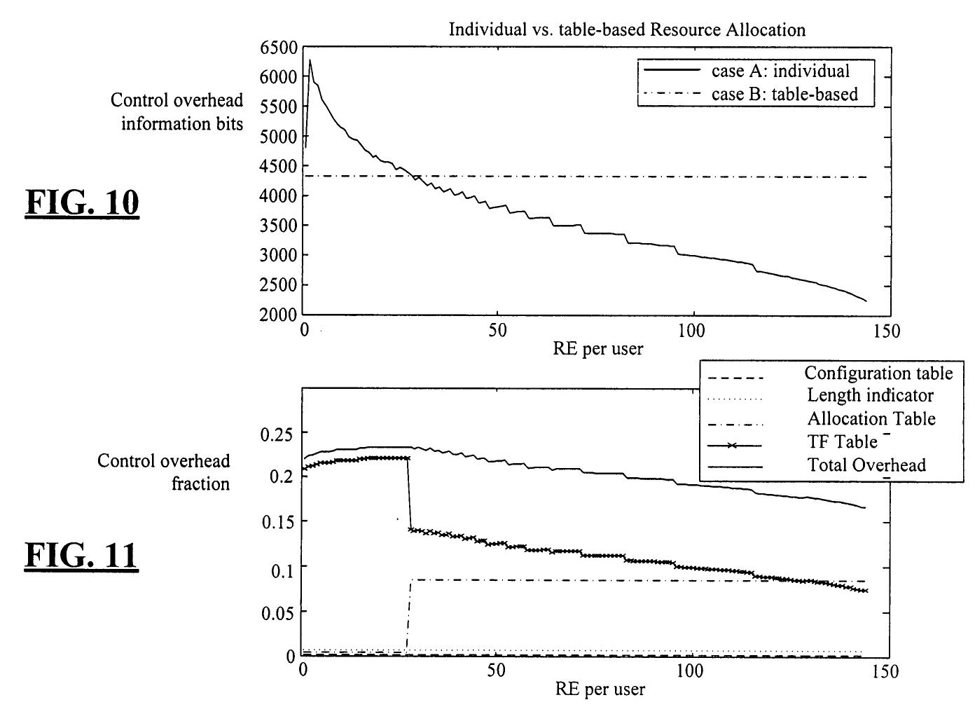

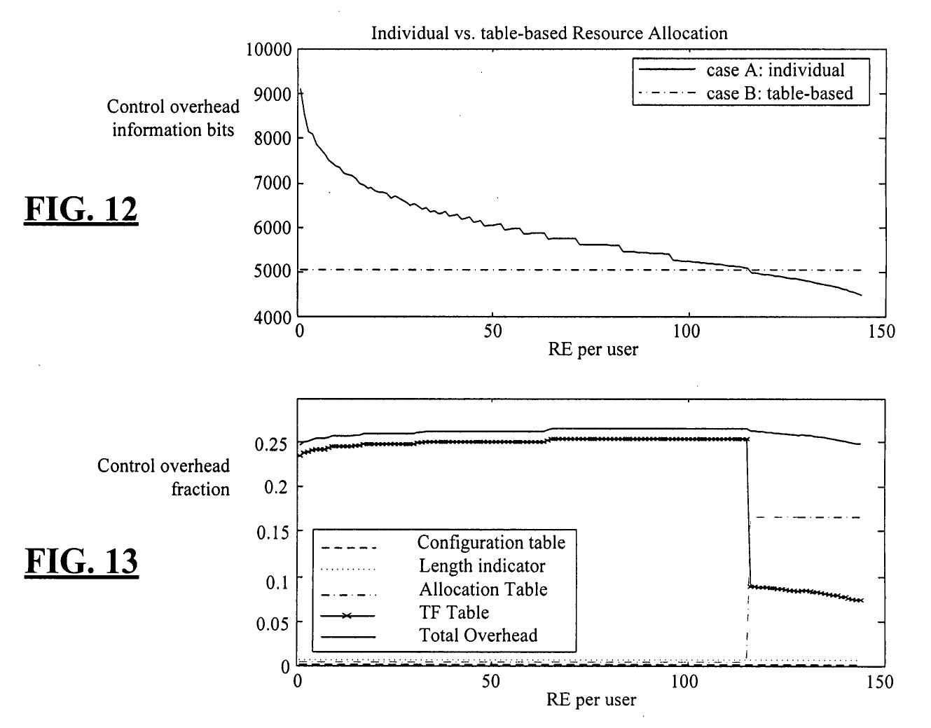

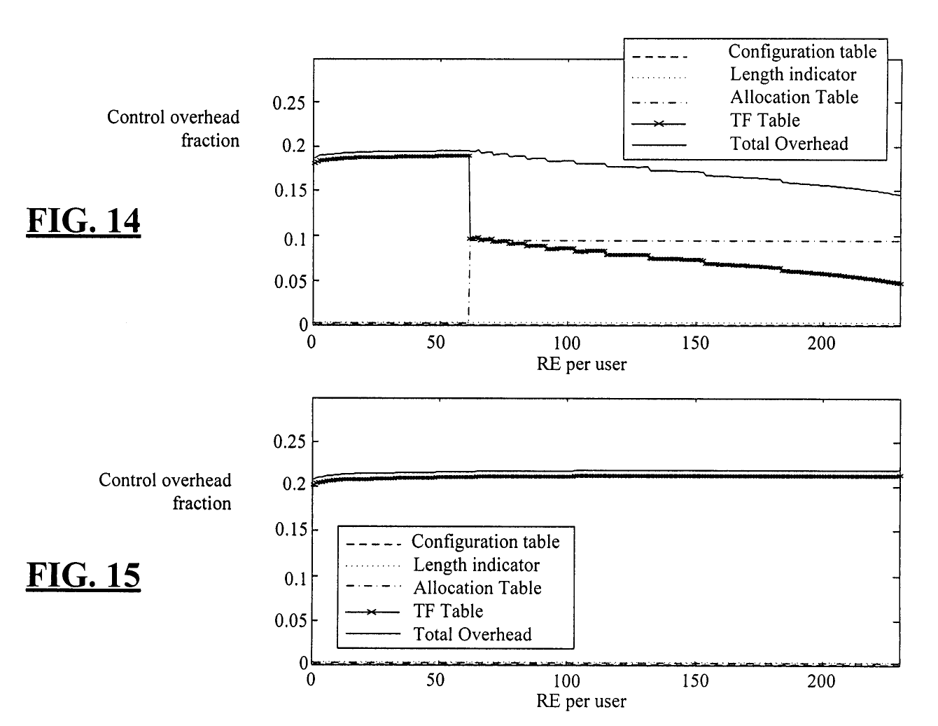

The FIGS. 6-15 show different operation conditions for the WINNER FDD and TDD mode, ranging from only 8 active users to 1280 users that can be scheduled in the next slot and spans scenarios where many users get small allocations (few RE per users) up to allocations of a few high-rate users (many RE per users).

FIGS. 6, 8, 10 and 12 compare for different number of RE per user, whether an individual signalling of the allocated RE or a table-based approach is beneficial. It is shown that this depends on the scenario and therefore switching between these approaches is beneficial and allows keeping overhead low in all cases.

The remaining FIGS. 7, 9, 11, and 13-15 show the total control overhead fraction for the different scenarios. It is shown that control overhead can be kept low for both physical layer modes, from very few to more than 1000 users that can be scheduled, and for any configuration from many users with small allocations to few users (or a single user) with large allocations.

Further optimizations in the format of the transport format table might provide additional savings.

These investigations focussed on the so-called frequency-adaptive mode in WINNER, where modulation is adapted in each layer of the RE and irregularly dispersed allocation of the RE to one user is possible. In terms of control channel overhead, this mode can be considered worst-case. Overhead can significantly be reduced for the non-frequency-adaptive mode, since there modulation information is only required once per codeword. Furthermore the use of regular RE allocation allows efficient encoding of the RE allocation.

As mentioned, the present invention is applicable, without limitation, to the LTE, or Long Term Evolution (also known as 3.9G), referring to research and development involving the Third Generation Partnership Project (3GPP) aimed at identifying technologies and capabilities that can improve systems such as the UMTS. The present invention is related to LTE work that is taking place in 3GPP.

Generally speaking, a prefix of the letter “E” in upper or lower case signifies LTE, although this rule may have exceptions. The E-UTRAN consists of eNBs (E-UTRAN Node B), providing the E-UTRA user plane (RLC/MAC/PHY) and control plane (RRC) protocol terminations towards the UE. The eNBs interface to the access gateway (aGW) via the S1, and are inter-connected via the X2.

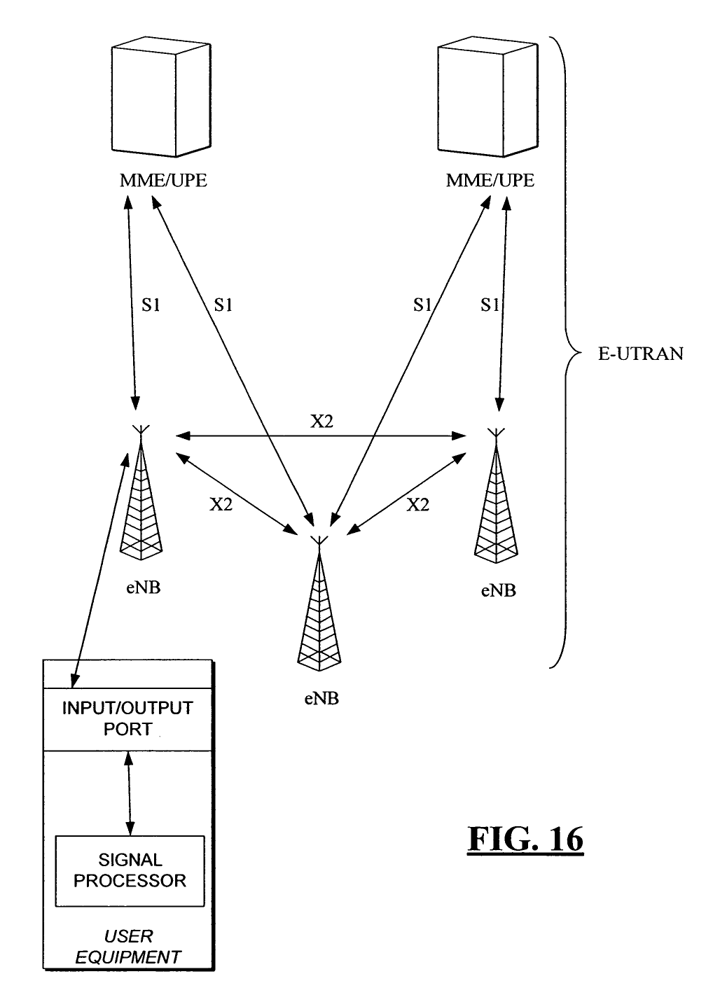

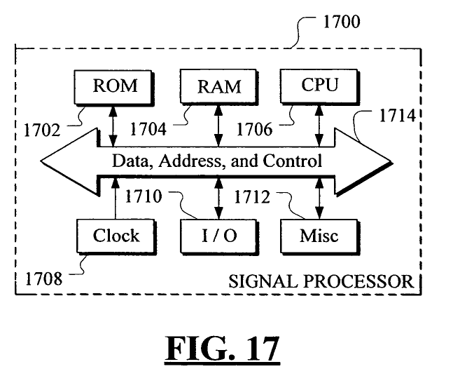

An example of the E-UTRAN architecture is illustrated in FIG. 16. This example of E-UTRAN consists of eNBs, providing the E-UTRA user plane (RLC/MAC/PHY) and control plane (RRC) protocol terminations towards the UE. The eNBs are interconnected with each other by means of the X2 interface. The eNBs are also connected by means of the S1 interface to the EPC (evolved packet core) more specifically to the MME (mobility management entity) and the UPE (user plane entity). The S1 interface supports a many-to-many relation between MMEs/UPEs and eNBs. The S1 interface supports a functional split between the MME and the UPE. The MMU/UPE in the example of FIG. 16 is one option for the access gateway (aGW).

In the example of FIG. 16, there exists an X2 interface between the eNBs that need to communicate with each other. For exceptional cases (e.g. inter-PLMN handover), LTE_ACTIVE inter-eNB mobility is supported by means of MME/UPE relocation via the S1 interface. The eNB may host functions such as radio resource management (radio bearer control, radio admission control, connection mobility control, dynamic allocation of resources to UEs in both uplink and downlink), selection of a mobility management entity (MME) at UE attachment, routing of user plane data towards the user plane entity (UPE), scheduling and transmission of paging messages (originated from the MME), scheduling and transmission of broadcast information (originated from the MME or O&M), and measurement and measurement reporting configuration for mobility and scheduling. The MME/UPE may host functions such as the following: distribution of paging messages to the eNBs, security control, IP header compression and encryption of user data streams; termination of U-plane packets for paging reasons; switching of U-plane for support of UE mobility, idle state mobility control, SAE bearer control, and ciphering and integrity protection of NAS signaling.

The invention is related to LTE, although the solution of the present invention may also be applicable to present and future systems other than LTE. FIG. 16 shows a signal processor such as shown in detail in FIG. 17 in the user equipment coupled to an input/output port with which it communicates with eNBs of the E-UTRAN. Although a signal processor is shown only within the UE, it should be realized that a similar signal processor will be present in each element of the E-UTRAN and each such element will likewise have one or more input/output ports coupled thereto in order to communicate with other elements of the E-UTRAN, UEs and the core network.

FIG. 17 shows a general purpose signal processor 1700 such as shown within the User Equipment of FIG. 16 suitable for carrying out the protocol construction, formatting and signal processing functions described above. It includes a read-only-memory (ROM) 1702, a random access memory (RAM) 1704, a central processing unit (CPU) 1706, a clock 1708, an input/output (I/O) port 1710, and miscellaneous functions 1712, all interconnected by a data, address and control (DAC) bus 1714. The ROM is a computer readable medium that is able to store program code written to carry out the various functions described above in conjunction with the RAM, CPU, I/O, etc. Of course, it should be realized that the same signal processing function may be carried out with a combination of hardware and software and may even be carried out entirely in hardware with a dedicated integrated circuit, i.e., without software.

What is claimed is:

1. A Method, comprising:
transmitting or receiving resource allocation information over a control channel of a radio interface in which resources for said transmitting or receiving are adaptively allocated in several dimensions and in several parts so that said resources are individually and flexibly allocated to different terminals of different users receiving said information over said radio interface, and
separately coding said information before said transmitting or separately decoding said information after said receiving.

2. The method according to claim 1, wherein said resources of said control channel are limited and said information has an adaptive length depending on actual information transmitted or received over said control channel.

3. The method according to claim 2, wherein the adaptive length of the information allows for transmission to all terminals without using all of said limited resources of the control channel so that any remaining resource allocation information resources of the control channel are adaptively available for another purpose.

4. The method according to claim 1, wherein said several dimensions include time, frequency, and space.

5. The method according to claim 1, wherein said several parts include parts decodable by all terminals receiving said information over said radio interface and parts decodable only by a subset of the terminals, including possibly only one terminal.

6. The method according to claim 1, wherein said transmitting or receiving is of parts sent or received with different temporal update rates.

7. The method according to claim 1, wherein said transmitting or receiving is of parts of the information sent to or received by one or more terminals in different control groups of terminals with different link adaptation.

8. The method according to claim 7, wherein said link adaptation includes one or more of adaptive coding, modulation, power, and spatial scheme.

9. The method according to claim 7, wherein said transmitting or receiving is of parts sent to or received in different control groups, said parts having adaptive length and information on a position of a part sent to a respective control group.

10. The method according to claim 1, wherein information of previously transmitted or received parts is used to influence a format of following parts.

11. The method according to claim 7, wherein information contained in a particular part is for influencing a format of any one or more of the following: number of control groups, maximum number of terminals or users in each control group, maximum number of control elements allocated to one particular terminal or user, a format of resource allocation information, an actual number of terminals or users in each control group, a number of resource elements allocated to a terminal or user.

12. The method according to claim 1, comprising switching between different formats of the resource allocation information.

13. The method according to claim 12, which uses a format that maps an identification of a terminal or user to an implicitly given order of address resource elements.

14. The method according to claim 13, wherein said identification is calculated based on a-priori knowledge of a subset of scheduled terminals or users.

15. The method according to claim 12, which switches a format that indicates an index for a particular set of resources for each terminal or user.

16. The method according to claim 15, where the index is derived based on a-priori knowledge of a number of assigned resources k_i,j and a total number of resources that can be allocated to a control group Ri.

17. Apparatus configured to transmit or receive resource allocation information over a control channel of a radio interface in which resources for transmitting or receiving are adaptively allocated in several dimensions and in several parts so that said resources are individually and flexibly allocated to different terminals of different users receiving said information over said radio interface, and configured to separately code said information before said transmitting or separately decode said information after said receiving.

18. The apparatus according to claim 17, wherein said resources of said control channel are limited and said information has an adaptive length depending on actual information transmitted or received over said control channel.

19. The apparatus according to claim 18, wherein the adaptive length of the information allows for transmission to all terminals without using all of said limited resources of the control channel so that any remaining resource allocation information resources of the control channel are adaptively available for another purpose.

20. The apparatus according to claim 17, wherein said several dimensions include time, frequency, and space.

21. The apparatus according to claim 17, wherein said several parts include parts decodable by all terminals receiving said information over said radio interface and parts decodable only by a subset of the terminals, including possibly only one terminal.

22. The apparatus according to claim 17, wherein said transmitting or receiving is of parts sent or received with different temporal update rates.

23. The apparatus according to claim 17, wherein said transmitting or receiving is of parts of the information sent to or received by one or more terminals in different control groups of terminals with different link adaptation.

24. The apparatus according to claim 23, wherein said link adaptation includes one or more of adaptive coding, modulation, power, and spatial scheme.

25. The apparatus according to claim 23, wherein said transmitting or receiving is of parts sent to or received in different control groups, said parts having adaptive length and information on a position of a part sent to a respective control group.
